(19) United States
(12) Patent Application Publication
(10) Pub. No.: US 2025/0285172 A1
(43) Pub. Date: Sep. 11, 2025

(54) SYSTEM AND METHOD TO VIRTUALLY TRY CLOTHES

(71) Applicant: Adam Richard Secore, Liverpool, NY (US)

(72) Inventor: Adam Richard Secore, Liverpool, NY (US)

(21) Appl. No.: 18/601,121

(22) Filed: Mar. 11, 2024

(51) Int. Cl. G06Q 30/0601

(52) U.S. Cl. CPC G06Q 30/0643; G06Q 30/0631

(57) ABSTRACT

A system to virtually try clothes may include a transceiver and a processor. The transceiver may be configured to receive a user request including user information and a user selection of a product. The user selection may include a selection of a product store, from a plurality of product stores, and the product associated with the product store. The processor may be configured to obtain the user request from the transceiver and generate a user digital model based on the user information. The processor may be further configured to obtain an image of the product from an external server based on the user selection and overlay the image of the product on the user digital model responsive to obtaining the image. The processor may further cause the overlaid image to be displayed on a user device.

### BACKGROUND OF THE INVENTION

### Field of the Invention

The present invention generally relates to a system and method to enable a user to virtually try clothes, and more particularly to a system and method to enable a user to virtually try clothes using Augmented Reality (AR) technology.

### Description of the Related Art

With rapid urbanization and rising income levels of people, a lot of avenues are now available for people to buy products that cater to their requirements. For example, users have options to buy products from offline retail stores, or they may buy products online through e-commerce websites.

Generally, users visit offline retail stores to try clothes/accessories before purchasing them. For this, users have to travel to the retail stores, which may cause inconvenience to the user and may waste user's time and effort. In addition, carbon emission may increase due to such travelling, which may accelerate the pace of global warming.

While buying products online through e-commerce websites may be convenient for the users and may help reduce their carbon footprint, there are known instances where the products purchased from conventional e-commerce websites do not meet user's expectations when the purchased products are delivered to the user. For example, there are known instances of clothes bought online not matching the purchaser's physique, as the purchaser was not able to try on the clothes before purchasing. Such instances may cause inconvenience to the users.

Accordingly, there is a need for a system and method that assists a user in purchasing clothes/accessories, without requiring the user to travel to offline retail stores.

### SUMMARY OF THE INVENTION

The following presents a simplified summary of the present disclosure in a simplified form as a prelude to the more detailed description that is presented herein.

In accordance with embodiments of the invention, there is provided a system (or an Augmented Reality (AR) application (app)) including a transceiver, a processor and a memory. The transceiver may be configured to receive a first user request. The first user request may include user information and a user selection of a product. The user selection may include a selection of a product store, from a plurality of product stores, and the product associated with the product store. The processor may be communicatively coupled to the transceiver. The processor may be configured to obtain the first user request from the transceiver and generate a user digital model based on the user information. The processor may further obtain an image of the product from an external server based on the user selection and overlay the image of the product on the user digital model responsive to obtaining the image. The processor may additionally cause a first overlaid image to display on a user device responsive to overlaying the image of the product on the user digital model.

In some embodiments, the user information may include a user image. In other embodiments, the user information may include user body measurements.

In certain embodiments, the processor may be further configured to receive an input from a user when the overlaid image is displayed on the user device. The input may indicate that the user desires to purchase the product. Responsive to receiving the input, the processor may transmit a purchase request to the external server.

In some embodiments, the system may further include a memory configured to store images of a plurality of existing clothes associated with a user. The processor may be further configured to obtain a second user request to virtually try an existing garment from the plurality of existing clothes. Further, the processor may obtain the images of the plurality of existing clothes from the memory responsive to obtaining the second user request. Furthermore, the processor may determine an image of the existing garment from the images of the plurality of existing clothes and overlay the image of the existing garment on the user digital model. In addition, the processor may cause a second overlaid image to display on the user device responsive to overlaying the image of the existing garment on the user digital model.

In certain embodiments, the processor may be further configured to generate a product recommendation based on user preferences and user purchase history, and transmit the product recommendation to the user device.

In accordance with another embodiment of the present disclosure, a method to facilitate a user in purchasing products online is disclosed. The method may include obtaining a user request. The user request may include user information and a user selection of a product. The user selection may include a selection of a product store, from a plurality of product stores, and the product associated with the product store. The method may further include generating a user digital model based on the user information. Further, the method may include obtaining an image of the product from an external server based on the user selection, and overlaying the image of the product on the user digital model responsive to obtaining the image. Furthermore, the method may include causing an overlaid image to display on a user device responsive to overlaying the image of the product on the user digital model.

In accordance with yet another embodiment of the present disclosure, a non-transitory computer-readable storage medium is disclosed. The storage medium includes instructions stored thereupon which, when executed by a processor, cause the processor to obtain a user request. The user request may include user information and a user selection of a product. The user selection may include a selection of a product store, from a plurality of product stores, and the product associated with the product store. The processor may further generate a user digital model based on the user information. Further, the processor may obtain an image of the product from an external server based on the user selection, and overlay the image of the product on the user digital model responsive to obtaining the image. Furthermore, the processor may cause an overlaid image to display on a user device responsive to overlaying the image of the product on the user digital model.

The present disclosure discloses a system that makes it easy for a user to try on clothing items virtually, without having to physically try them on. The system's personalized recommendations and AR technology make it easier for the user to find what the user is looking for, and the system's e-commerce platform makes it simple for the user to purchase the items that the user likes. The system enables the users to try on virtual clothing in real- time, providing an interactive and immersive shopping experience. The system may increase user satisfaction by eliminating the need for physical fittings and reducing the number of returns.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 depicts a user device capturing an image of a user, in accordance with embodiments of the invention;

FIG. 2 depicts the user device displaying an augmented reality image of the user overlaid with a product image, in accordance with embodiments of the invention;

FIG. 3 depicts a block diagram of a virtual fitting room system to facilitate the user in purchasing products online, in accordance with embodiments of the invention;

FIG. 4 depicts a flow diagram of a first method to facilitate the user in purchasing products online, in accordance with embodiments of the invention;

FIG. 5 depicts a plurality of features of the system of FIG. 3, in accordance with embodiments of the invention; and

FIG. 6 depicts a flow diagram of a second method to facilitate the user in purchasing products online, in accordance with embodiments of the invention.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

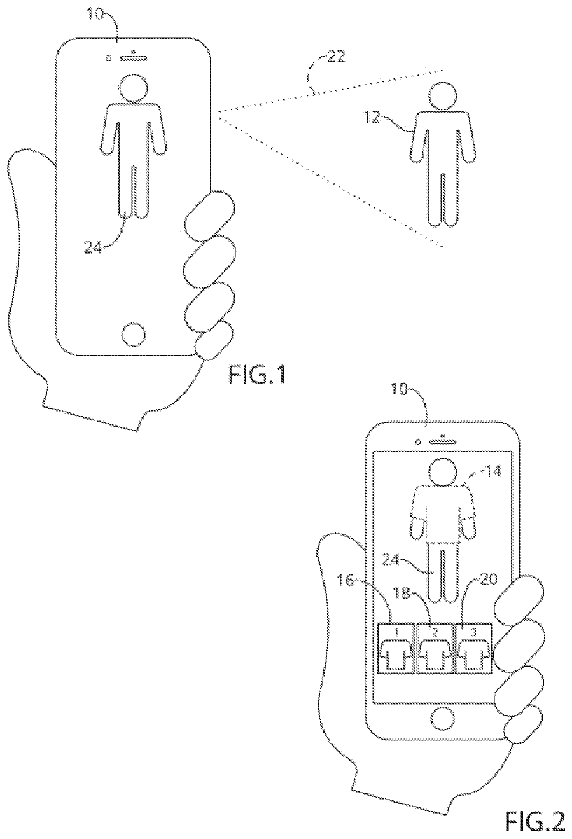

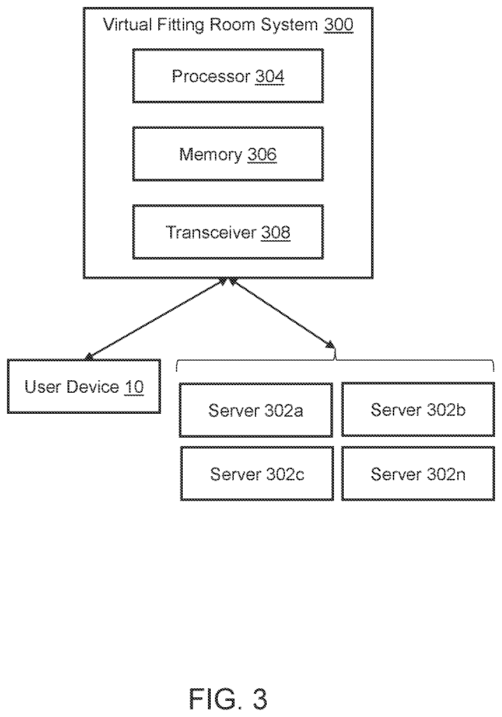

FIG. 1 depicts a user device 10 capturing an image of a user 12, in accordance with embodiments of the invention. FIG. 1 will be described in conjunction with FIGS. 2 and 3. FIG. 2 depicts the user device 10 displaying an augmented reality image 24 of the user 12 overlaid with an image of a product 14. FIG. 3 depicts a block diagram of a virtual fitting room system 300 (or system 300) to facilitate the user 12 in purchasing products online.

The system 300 may be hosted on a server and may be associated with a platform or an application (“app”) that may be accessed by the user 12 on the user device 10. The system 300 may be communicatively coupled with the user device 10 and a plurality of servers 302a, 302b, 302c, 302n (collectively referred to as servers 302) via a network, as shown in FIG. 3. The network, as described herein the present disclosures, illustrates an example communication infrastructure in which the connected devices discussed in various embodiments of this disclosure may communicate. The network may be and/or include the Internet, a private network, public network or other configuration that operates using any one or more known communication protocols such as, for example, transmission control protocol/Internet protocol (TCP/IP), Bluetooth®, BLE®, Wi-Fi, ultra-wideband (UWB), and cellular technologies such as Time Division Multiple Access (TDMA), Code Division Multiple Access (CDMA), Long-Term Evolution (LTE), and/or the like.

Each server 302 may be associated with a retailer/brand/label of clothes that may be selling respective clothes online via the system 300. For example, the server 302a may be associated with a clothing store/retailer/brand “A”, the server 302b may be associated with a clothing store/retailer/brand “B”, the server 302c may be associated with a clothing store/retailer/brand “C”, and so on. Each server 302 may be configured to store product information associated with the products owned by the respective retailer/brand. The product information may include, but is not limited to, product sizes, product images, product colors, product designs, product cost, type of material/textile used in the product, and/or the like. Responsive to receiving a request to obtain product information from the system 300, each server 302 may transmit the requested product information to the system 300 via the network described above.

The system 300 may include a processor 304, a memory 306 and a transceiver 308. In some embodiments, the memory 306 may store programs in code and/or store data for performing various operations in accordance with the present disclosure. The processor 304 may be configured and/or programmed to execute computer-executable instructions stored in the memory 306 for performing various functions in accordance with the disclosure. Consequently, the memory 306 may be used for storing code and/or data code and/or data for performing operations in accordance with the present disclosure.

In one or more embodiments, the processor 304 may be disposed in communication with one or more memory devices. The memory 306 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 306 may be one example of a non-transitory computer-readable storage medium and may be configured to store programs in code and/or store data for performing various operations in accordance with the disclosure. The instructions in the memory 306 may include one or more separate programs, each of which may include an ordered listing of computer-executable instructions for implementing logical functions.

In some embodiments, the transceiver 308 may be configured to receive a user request (e.g., a “first” user request) from the user 12 to virtually try on clothes. In certain embodiments, the user 12 may transmit the user request to the transceiver 308 via the user device 10. The user request may include user information. In one embodiment, the user information may be, for example, an image of the user 12 captured via the user device 10, shown as view 22 in FIG. 1. In another embodiment, the user information may be, for example, user's body measurements (and age) that the user 12 may input on the user device 10 (e.g., on an interface of the system 300 that may be displayed on the user device 10 when the user 12 accesses the system 300 on the user device 10). In an exemplary embodiment, the user's body measurements may include, but are not limited to, user's height, weight, measurements associated with chest, waist, hips, inseam, arms, neck, shoe size, glove size, head size, torso length, bra size for women, and/or the like.

In one or more embodiments, the user request may further include a user selection of the product 14 that the user 12 may be interested to virtually try on. In some embodiments, to select the product 14, the user 12 may first select a product store/retailer/brand, from a plurality of product stores/retailers/brands, that the user 12 may be interested in trying products of, from a drop down menu displayed on the interface of the system 300 on the user device 10. For example, the user 12 may select the clothing brand “B” (from the clothing brands “A”, “B” and “C” described above) to virtually try brand “B” clothes. Responsive to the user 12 selecting the clothing brand “B”, the system 300 may virtually route the user 12 (via the user device 10) to the server 302b associated with the clothing brand “B”. Stated another way, the system 300 may enable the user 12 to access a website or virtual inventory of the clothing brand “B” hosted on the server 302b. Responsive to accessing the virtual inventory of the clothing brand “B”, the user 12 may select the product 14 that the user 12 may be interested in virtually trying. In some embodiments, the user 12 may also select a size of the product 14 that the user 12 desires to virtually try.

The processor 304 may be configured to obtain the user request from the transceiver 308. Responsive to obtaining the user request, the processor 304 may generate a user digital model/avatar/augmented reality image 24, as shown in FIGS. 1 and 2, based on the user information included in the user request. Stated another way, responsive to obtaining the image of the user 12 and/or the user's measurements, the processor 304 may generate the avatar 24 of the user 12. The avatar 24 may be a digital image of the user 12, with proportionate physical dimensions.

Further, responsive to obtaining the user request and/or generating the avatar 24, the processor 304 may transmit, via the transceiver 308, a request to the server 302b to obtain product information associated with the product 14 selected by the user 12. Responsive to transmitting the request, the processor 304 may obtain the product information associated with the product 14 from the server 302b. In an exemplary aspect, the product information may include an image of the product 14. Responsive to obtaining the image of the product 14 from the server 302b, the processor 304 may overlay the image of the product 14 on the avatar 24, and cause the display screen of the user device 10 to display the overlaid image (or “augmented reality image” or a “first overlaid image”), as shown in FIG. 2. In this manner, the user 12 may virtually try the product 14, and check how the product 14 looks on the user 12 (specifically on the avatar 24 of the user 12). The user 12 may not be required to visit an offline retail store of the clothing brand “B” and may instead try on the product 14 via the user device 10.

In a scenario where the user 12 likes the product 14 after viewing the overlaid image, the user 12 may transmit a purchase request or purchase input to the transceiver 308 via the user device 10. The processor 304 may receive/obtain the purchase request from the transceiver 308, and transmit (via the transceiver 308) the purchase request to the server 302b. The purchase request may indicate that the user 12 desires to purchase the product 14. The processor 304 may further virtually route the user 12 (via the user device 10) to a payment portal associated with the server 302b, so that the user 12 may make the payment for the product 14 and complete the order process.

In some aspects, the system 300 may further enable the user 12 to compare the product 14 with existing clothes that the user 12 may already have in user's closet. In this exemplary aspect, the memory 306 may be configured to store images of a plurality of existing clothes associated with the user 12. To compare the product 14 with an existing garment (from the plurality of existing clothes) or to check how the product 14 may look along with the existing garment, the user 12 may first transmit, via the user device 10, a request to the system 300 to virtually try on the existing garment. The processor 304 may obtain such a request from the user 12, and may obtain the images of the plurality of existing clothes from the memory 306 responsive to obtaining the request. The processor 304 may further determine an image of the existing garment from the obtained images of the plurality of existing clothes. Responsive to determining the image of the existing garment, the processor 304 may overlay the image of the existing garment on the avatar 24 and may cause the user device 10 to display the overlaid image (or a “second overlaid image”) of the image of the existing garment and the avatar 24. In some aspects, the avatar 24 may already be overlaid with the image of the product 14. In this manner, the user 12 may check how the existing garment looks on the user 12 along with the product 14. In other aspects, the processor 304 may cause two separate overlaid images to be displayed simultaneously (e.g., side-by-side) on the user device 10, one with the avatar 24 and the product 14 and second with the avatar 24 and the existing garment. By viewing the two overlaid images displayed side-by-side, the user 12 may compare the product 14 with the existing garment.

In an exemplary aspect, the system 300 may be configured to store user's browsing history, user preferences, and purchase history in the memory 306. Based on user's browsing history and purchase history and the user information, the system 300 may recommend clothes (or transmit images of recommended clothes) to the user 12 via the user device 10. Examples of recommended clothes 16, 18, 20 are shown in FIG. 2.

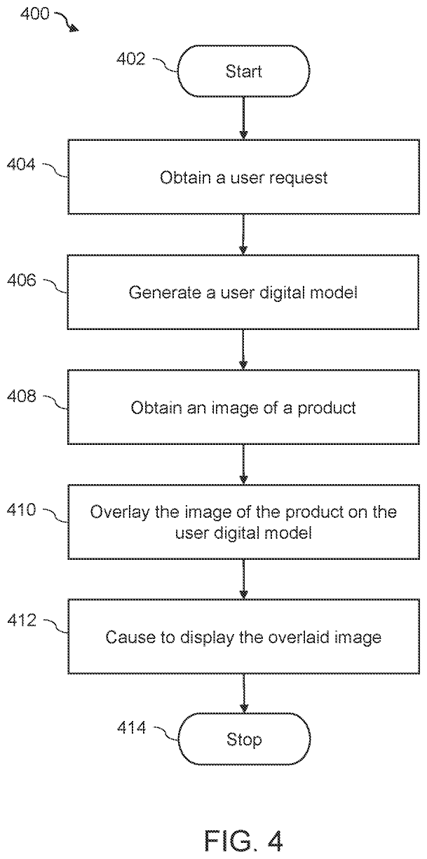

FIG. 4 depicts a flow diagram of a first method 400 to facilitate the user 12 in purchasing products online, in accordance with embodiments of the invention. FIG. 4 may be described with continued reference to FIGS. 1-3. The following process is exemplary and not confined to the steps described hereafter. Moreover, alternative embodiments may include more or less steps than are shown or described herein and may include these steps in a different order than the order described in the following example embodiments.

At step 402, the method 400 may start. At step 404, the method 400 may include obtaining, by the processor 304, the user request to virtually try on clothes. As described above, the user request may include the user information and the user selection of the product 14. At step 406, the method 400 may include generating, by the processor 304, the user digital model/avatar/augmented reality image 24 based on the user information. At step 408, the method 400 may include obtaining, by the processor 304, the product information (e.g., product image) associated with the product 14 selected by the user 12 from the server 302b.

At step 410, the method 400 may include overlaying, by the processor 304, the product image on the avatar 24. At step 412, the method 400 may include causing, by the processor 304, the user device 10 to display the overlaid image on the display screen of the user device 10.

At step 414, the method 400 may end.

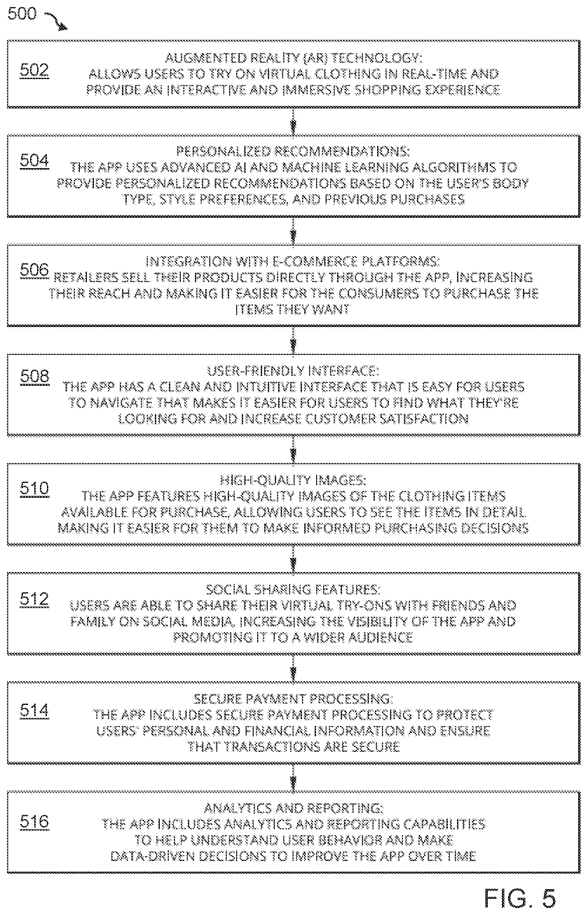

FIG. 5 depicts a plurality of features 500 of the system 300, in accordance with embodiments of the invention. The features 500 may include a first feature 502 “Augmented Reality (AR) technology”. The first feature 502 allows the user 12 to try on virtual clothing in real-time and provide an interactive and immersive shopping experience. The core component of the system 100 is the AR technology itself, which allows the users to see virtual clothing items superimposed on their real-world bodies.

The features 500 may further include a second feature 504 “Personalized Recommendations”. The system 300 uses advanced Artificial Intelligence (AI)/Machine Learning (ML) algorithms to provide personalized recommendations based on user's body type, style preferences, and purchase history. The personalized recommendation component is important in order to provide the users with relevant and personalized product recommendations based on their preferences and past browsing/purchase behavior.

The features 500 may further include a third feature 506 “Integration with E-commerce platforms”. Retailers may sell their products directly through the system 300, increasing their reach and making it easier for the users/customers to purchase the items they want. The system 300 enables the users to purchase clothing items via integrated retail websites, inventory platforms or e-commerce platforms.

The features 500 may further include a fourth feature 508 “User-friendly interface”. The system 300/app may provide a clean and intuitive interface that may be easy for the users to navigate. The interface may further make it easier for the users to find what they are looking for and increase customer satisfaction. A user-friendly interface may make it easier for the users to navigate the system 300/app and use the AR technology.

The features 500 may further include a fifth feature 510 “High quality images”. The system 300/app may feature high quality images of the clothing items available for purchase, allowing the users to see the items in detail, making it easier for them to make an informed purchasing decision.

The features 500 may further include a sixth feature 512 “Social sharing features”. The system 300 may enable the users to share their virtual try-ons with friends and family on social media, increasing the visibility of the system 300/app and promoting it to a wider audience.

The features 500 may further include a seventh feature 514 “Secure payment processing”. The system 300/app provides secure payment processing to protect users' personal and financial information and ensure that the transactions are secure.

The features 500 may further include an eighth feature 516 “Analytics and reporting”. The system 300/app may include analytics and reporting capabilities to understand user's behavior and make data-driven decisions to improve the system 300/app over time.

In some aspects, the system 300 may provide access to additional product categories beyond clothing, such as accessories (e.g., necklaces, bracelets, scarves, purses, etc.) and footwear, to expand the system 300/app's product offerings and appeal to a wider audience.

In some aspects, to successfully launch the system 300, an operator may perform a number of tasks/activities. For example, the operator may first perform research and ideation to check market trends in the AR industry and fashion technology industry. The operator may then prototype the system 300, develop and test the system 300. The operator may then deploy the system 300. Responsive to deploying, the operator may perform marketing and promotion, and maintenance and updates on a regular basis.

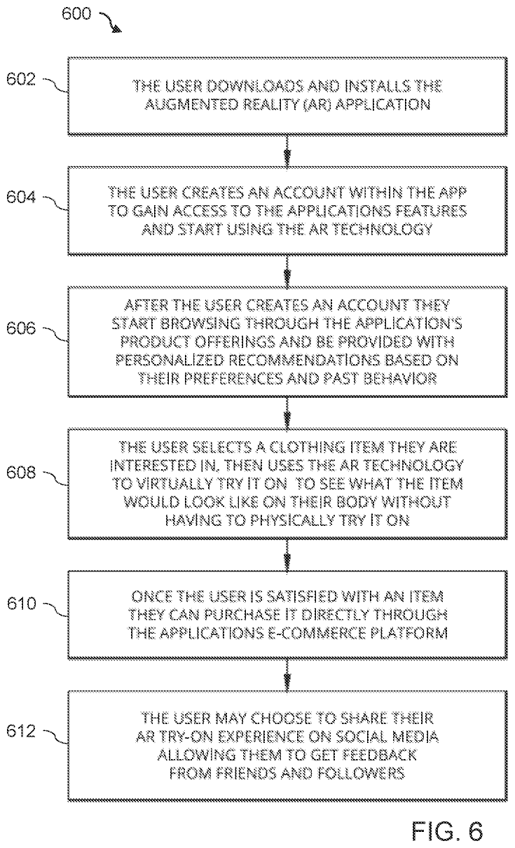

FIG. 6 depicts a flow diagram of a second method 600 to facilitate the user 12 in purchasing products online, in accordance with embodiments of the invention. FIG. 6 may be described with continued reference to FIGS. 1-5. The following process is exemplary and not confined to the steps described hereafter. Moreover, alternative embodiments may include more or less steps than are shown or described herein and may include these steps in a different order than the order described in the following example embodiments.

At step 602, the user 12 may download the app associated with the system 300 (or “AR clothing app”) from an app store and install the app on the user device 10. At step 604, the user 12 may create an account within the app, which would allow the user 12 to access the app's features and start using the AR technology. After the user 12 has created the account, at step 606, the user 12 may start browsing through the app's product offerings. The app may provide the user 12 with personalized recommendations based on user's preferences and past behavior, making it easier for the user 12 to find what the user 12 may be looking for.

At step 608, the user 12 may select a clothing item (e.g., the product 14) that the user may be interested in, and then use the AR technology to virtually try it on. This allows the user 12 to see what/how the item would look like on the user's body without having to physically try it on. If the user 12 is satisfied with the item, at step 610, the user 12 may purchase the item directly through the app's e-commerce platform. At step 612, the user 12 may also choose to share the user's AR try-on experience on social media, allowing the user 12 to get feedback from friends and followers.

A person ordinarily skilled in the art may appreciate from the description above that the system 300/AR clothing app makes it easy for a user to try on clothing items virtually, without having to physically try them on. The app's personalized recommendations and AR technology make it easier for the user to find what the user is looking for, and the app's e-commerce platform makes it simple for the user to purchase the items that the user likes. The app enables the users to try on virtual clothing in real-time, providing an interactive and immersive shopping experience. The app may increase user satisfaction by eliminating the need for physical fittings and reducing the number of returns.

The system 300/AR clothing app may be a virtual mall with access to major clothing labels, which allows shoppers the opportunity to “try on” clothes before purchase from major retail stores. In the app, there may be a drop down menu for all participating major retail stores for clothing, and the user 12 may select a store from the drop down menu. The user 12 may then be virtually routed to the retailer's website. Once a selection of the clothing item is made from the retailer's website by the user 12, the garments' dimensions and details may be sent to the fitting room of the app where it can be viewed on a proportionate avatar of the user (i.e., the avatar 24), constructed prior to shopping. The item may then be placed into the shopping cart of the user 12 on the app. The user 12 may access multiple stores, and the system 300/app may track clothing items so that an outfit can be put together within one shopping cart. Once the items are purchased, the information will be sent to the respective retailers for processing the purchase.

In further aspects, once the user 12 downloads the app on the user device 10, there may be displayed an easy step-by-step guide on the user device 10 for the user 12 to make the avatar 24. For example, the user 12 may start by selecting male or female, and then adding pictures as necessary to create a 3D facial rendition of the user 12. The user 12 may then input user's body measurements as described above. All measurements input will alter the avatar 24 to reflect in proper scale, so that when the clothing items are tried on, it will be viewed as if the user 12 was looking in a mirror and actually seeing the fit.

Once the avatar 24 may be created, the user 12 may shop on the system 300/app. Once an item may be selected by the user 12, based on the dimensions of the item and the dimensions/measurements of the user 12, the system 300/app may properly superimpose a 3D rendition on the avatar 24. Colors of the items may be selected based on only those colors that are provided by the item's retailers/manufacturers. Stated another way, if the item is not available in pink, the system 300 may not offer to sell the item in pink color.

Further, the user 12 may be able to try on item after item. Stated another way, the user 12 may create layers of items. For example, if a male were shopping for a sport coat and undershirt, the shirt may stay in place with the sport coat over it, allowing it to be viewed as if it were being worn in a proper fitting room.

In some aspects, a notification may be sent by the system 300 to the user 12 to alert the user 12 of sales items available from the stores. The system 300 may gather sales information from the retailers.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A system comprising:
a transceiver configured to receive a first user request, wherein the first user request comprises:
user information; and
a user selection of a product, wherein the user selection comprises a selection of a product store, from a plurality of product stores, and the product associated with the product store; and
a processor communicatively coupled to the transceiver, wherein the processor is configured to:
obtain the first user request from the transceiver;
generate a user digital model based on the user information;
obtain an image of the product from an external server based on the user selection;
overlay the image of the product on the user digital model responsive to obtaining the image; and
cause a first overlaid image to display on a user device responsive to overlaying the image of the product on the user digital model.

2. The system of claim 1, wherein the user information comprises a user image.

3. The system of claim 1, wherein the user information comprises user body measurements.

4. The system of claim 1, wherein the processor is further configured to:
receive an input from a user when the first overlaid image is displayed on the user device, wherein the input indicates that the user desires to purchase the product; and
transmit a purchase request to the external server responsive to receiving the input.

5. The system of claim 1 further comprising a memory configured to store images of a plurality of existing clothes associated with a user.

6. The system of claim 5, wherein the processor is further configured to:
obtain a second user request to virtually try an existing garment from the plurality of existing clothes;
obtain the images of the plurality of existing clothes from the memory responsive to obtaining the second user request;
determine an image of the existing garment from the images of the plurality of existing clothes;
overlay the image of the existing garment on the user digital model; and
cause a second overlaid image to display on the user device responsive to overlaying the image of the existing garment on the user digital model.

7. The system of claim 1, wherein the processor is further configured to:
generate a product recommendation based on user preferences and user purchase history; and
transmit the product recommendation to the user device.

8. A method comprising:
obtaining, by a processor, a user request, wherein the user request comprises:
user information; and
a user selection of a product, wherein the user selection comprises a selection of a product store, from a plurality of product stores, and the product associated with the product store;
generating, by the processor, a user digital model based on the user information;
obtaining, by the processor, an image of the product from an external server based on the user selection;
overlaying, by the processor, the image of the product on the user digital model responsive to obtaining the image; and
causing, by the processor, an overlaid image to display on a user device responsive to overlaying the image of the product on the user digital model.

9. The method of claim 8, wherein the user information comprises a user image.

10. A non-transitory computer-readable storage medium having instructions stored thereupon which, when executed by a processor, cause the processor to:
obtain a user request, wherein the user request comprises:
user information; and
a user selection of a product, wherein the user selection comprises a selection of a product store, from a plurality of product stores, and the product associated with the product store;
generate a user digital model based on the user information;
obtain an image of the product from an external server based on the user selection;
overlay the image of the product on the user digital model responsive to obtaining the image; and
cause an overlaid image to display on a user device responsive to overlaying the image of the product on the user digital model.
